(19) United States
(12) Patent Application Publication
(10) Pub. No.: US 2024/0114885 A1
(43) Pub. Date: Apr. 11, 2024

(54) Special hook setting device for fishermen called a Guard Dog

(71) Applicant: Monty Sheets, Elwood, IN (US)

(72) Inventor: Monty Sheets, Elwood, IN (US)

(21) Appl. No.: 17/962,478

(22) Filed: Oct. 8, 2022

(51) Int. Cl. A01K 87/04

(52) U.S. Cl. CPC A01K 87/04

(57) ABSTRACT

A hook setting device which is controlled by a trigger sprung and activated by a tension string while unaffecting the fishing line. The device has an adjustable trigger and includes a trigger body with a nose to engage the rod eyelet, a tension string, a way to movably fasten the tension string at one end into multiple positions which in turn establishes the release force to set the hook, and a way to fasten the tension string to a fixed point. Thus the fishing pole with its rod eyelet attached to the nose of the trigger and its handle fixed in a rod holder, is bent into an arched position. When a fish pulls on the hook on the line, the nose dislodges from the rod eyelet of the arched rod and creates a spring force that immediately sets the hook into a mouth of the fish.

### CROSS-REFERENCE TO RELATED APPLICATIONS

None.

### FIELD OF INVENTION

This invention relates to a special hook setting device for fishermen called a Guard Dog. The device relates to fishing accessories and more particularly, relates to a fishhook setting apparatus that will automatically and quickly set a hook when a fish bites. Particularly this product is related to an automatic, self-setting quick release rod holder that automatically sets a fishing hook in a fish's mouth upon a fish strike and a strike-setting assembly for use with an unmanned fishing rod including a hook-setting device carried by a fishing pole holder, and more particularly, to a hook-setting device. The device relates to a device or tool to automatically set a hook when fishing and the pole is unmanned. Finally, the device relates to fish pole holders of the type including an automatic fishhook setter and relates to fishing tackle and particularly to mechanism associated with a rod or pole for automatically setting the hook when a fish strikes.

### FEDERALLY SPONSORED RESEARCH

None.

### SEQUENCE LISTING OR PROGRAM

None.

### BACKGROUND—FIELD OF INVENTION and PRIOR ART

As far as known, there are no special hook setting device for fishermen called a Guard Dog or the like. It is believed that this product is unique in its design and technologies. This background as to automatic hook setting devices for fishing should be useful. Fishing is a very popular sport. Fishing is fun and sometimes easy if the fish are biting. The difficult thing for novices and experienced fishermen and women is to properly set the hook. At the moment a fish takes the bait, the fish is most vulnerable to being hooked. Unfortunately, inexperience and inattention often leave the hook empty, and the fish fed with the bait. When a fish nibbles, bites, or otherwise takes the bait, fishermen customarily jerk the rod to set the hook into the fish, so it does not reject the bait and escape unhooked. Often, fishermen cast out a line but leave the pole unmanned, for example, if they are using multiple poles or have to step aside for a while. If the fisherman is not holding the pole when the fish bites, the fish may get away without being hooked. When a bite occurs yielding only a slight tug on the line, the invention allows the pole to set the hook even instantly sharply while being unmanned.

A fishing pole is typically comprised of a flexible rod with a spool of fishing line coupled to the rod at a proximal end, near a handle of the rod. The fishing line is guided to the distal end of the rod by loops on the rod. A hook is attached to the free end of the fishing line, and a lure is attached to the hook. When a fish bites the lure and pulls on the line, the fisherman jerks the fishing rod upward to set the hook into the mouth of the fish. However, waiting for a bite can require constant attention through long periods of inactivity. Fishing often requires patience and fishermen do not like to constantly hold their rod and reel assemblies until the fish bites. Fishermen often fail to notice that a fish is biting their bait or lure until it is too late to set the hook. This can be the result of inattentiveness, or because the fisherman is tending two or more poles and the bite occurs on the pole the fisherman is not tending.

Additionally, great skill is required to properly set the hook in the mouth of a fish. If a fisherman does not pull on the fishing rod quickly enough when the fish bites, the hook will not be set. The fishhook-setting technique used by fishermen is a manual quick jerk of the fishing rod when a fish strikes (takes the baited hook or lure). This allows a quick, secure set of the hook, before the fish can spit it out or before the fish can deeply swallow it. If the fish is able to disengage from the hook, it escapes unhooked. If the hook becomes embedded in the stomach or gills, injury to the fish is increased—especially undesirable in catch-and-release fishing. Less injury occurs when the fish is hooked in the lip, jaw, or cheek area, such as when the hook is set quickly. However, at times the manual quick jerk hook-setting technique is undesirable or difficult. For instance, the fisherman may temporarily leave the rod unmanned, such as when using multiple rods, when stepping away momentarily, or when distracted. If the rod is unmanned, a tentative bite may not set the hook. The strike-setting assembly of the present invention enables an unmanned rod to set the hook quickly and efficiently, plus advantageously supplies a choice of trigger sensitivities for differing fishing environments, including locations, weather conditions, and sizes of fish.

The general idea of setting the hook with an automatic hook-setting device is known in the art. Some of the prior art hook-setting devices make use of a tether to bow the rod and a mechanical trigger to release the rod-bending cord. However, problems occur with the hook-setting devices of the prior art. These problems include awkward setup; multiple or unattached parts that can become separated and lost; relatively large size causing inconvenience in use, storage, and transport; inconvenient attachment to the rod, thus interfering with retrieval of the fish from the water; lack of mechanical dependability; and lack of adjustability to match the fishing environment, thus resulting in lost fish. Some are incorporated into a proprietary fishing pole, thus precluding use with the fisherman's current set of poles as well as being complex and costly. Prior art includes many inventions directed to the improvement of the chances for people to catch fish. Most prior art hook setting devices utilize either a separate pole or a pole holder involving large, complex, and more expensive systems. Other prior art hook setting devices utilize a cord to bend the pole and a tripping device to set the hook.

To avoid the above-identified drawbacks, a fisherman could use a fishing pole holder that automatically sets the hook in the mouth of a fish when the fish bites the lure. Automatic fishhook setters have been around for some time. Typically, automatic fishhook setters comprise a holder for receiving the handle of a fishing rod and a hook setting mechanism that quickly pulls the fishing rod back when a fish bites the lure. Such fishhook setters allow fishermen to relax or perform other tasks while waiting for a fish to bite on the lure. Furthermore, automatic fishhook setters reduce the high level of attention and skill normally required to catch a fish. There have been prior attempts to solve this problem.

One solution has been to have a triggering stick that fits in the last eyelet of the pole and has a string that connects to an interior eyelet. The pole is bent when the triggering stick is placed in the last eyelet, since the string is shorter than the straight length of the pole. The fishing line is placed through a groove at the end of the triggering stick and when a fish bites the lure the line is pulled, which pulls the triggering stick out of the eyelet and cause the pole to snap back into position. Unfortunately, it is often difficult to set the triggering stick in the last eyelet. The triggering stick also flies free when the line is pulled on by the fish and can get wrapped around the fishing line or otherwise impede the process of reeling in the fish. Once the fish is hooked, the angler typically needs to retrieve the line and fish by hand. That process leads to cuts on the hand and damaged fishing line. In addition, handicapped or elderly anglers do not easily use those devices. Thus, there exists a need for a hook setter that is easy to use and does not impede the process of reeling in the fish.

### Problem Solved

The improvement and problem solved as to automatic hook setting devices for fishermen are many. With the Guard Dog, the trigger sensitivity adjustment is made on the tension cord and not the fishing line. Also, the adjustment on some devices are merely two or three settings. This is replaced by multiple settings available on the Guard Dog. Settings can be made from a heavy release (multiple pounds) to a very light release (less than an ounce) and anywhere in between. This is a virtual micro-setting ability from more than a pound to a few ounces, to even fractions of an ounce. The release force on the Guard Dog is virtually unlimited per the multiple, micro-setting which permits an ideal state. Guard Dog is a universal design that allows it to fit most fishing rods with different pole lengths, line weights, and pole eyelets. It has a simple way to adjust trigger sensitivity and release force by merely sliding a tension knot from a light to a heavy position, or anywhere in between. The device is fast to install onto rod eyelets and the fishing line is easily placed into the fishing line groove. There is no counterweight balance required and the device is a compact size that easily fits into most tackle boxes or pocket—i.e., convenient, and portable. There are no tools required to attach the Guard Dog to the fishing pole. The Guard Dog has an inexpensive cost since it uses known processes and materials to manufacture. There are few component parts—no springs, bearings, or small component parts to wear out parts and Guard Dog is not a complex design. It works with different rod holders and tension cord security means/fixed points/stakes/tie-offs. And Guard Dog has a better sensitivity that can help the person to catch the fish. The fisherman's reaction time to set the hook is removed and the setting of the hook is now based on the snap of a trigger and not on a fisherman's/human's reaction time after seeing bobber movement or feeling movement by the fish and hook.

### PRIOR ART

As far as known, there are no special hook setting devices for fishermen called a Guard Dog or the like. It is believed that this product is unique in its design and technologies. A novelty search revealed:
A. Various Internet—fishAmatic® and internet/Amazon® finds show cheap, gimmick springs that work off the fishing line itself to try and vary tension.
B. U.S. Pat. No. 975,822 by Becker & Poggensee issued in 1910 for an Automatic Fish Catching Device. This invention relates to devices for automatically operating a fishing line to give the same an abrupt pull when the hook, or bait, is grasped by the fish.
C. U.S. Pat. No. 2,147,917 by Noren issued in 1939 for an Automatic Fishhook Setter and Shock Absorber. It is an invention that relates to the art of fishing devices and more particularly to an automatic fishhook setter and shock absorber.
D. U.S. Pat. No. 2,984,039 by Willey issued in 1961 for a Hook Setting Mechanism for Fishing Rods and Poles. This is fishing tackle and particularly a mechanism associated with a rod or pole for automatically setting the hook when a fish strikes. It is to provide a simple but highly efficient device for holding a fishing rod or pole having mechanism combined therewith for releasing tension on the rod or pole when a fish strikes, to cause the inherent resiliency of the rod or pole to automatically set the hook in the striking fish.
E. U.S. Pat. No. 3,914,894 by Kobza issued in 1975 is for an Automatic Fishhook Setter. It shows an automatic fishhook setter which includes a tubular support for the butt of a fishing pole. The tubular butt support is pivotally mounted and has a spring arranged to counteract the normal pull of the fishline but allow the pole to drop when fish pulls on the bait.
F. U.S. Pat. No. 4,872,280 by Smith issued in 1989 for an Automatic Fishhook Setting Device. This shows an automatic fishhook setting device for use with the tip eyelet and the spaced eyelets of a fishing rod; wherein the device includes a tether member adapted to releasably engage one of the spaced eyelets and a contoured leaf spring member attached on one end to the tether member and having a shallow leaf spring segment formed on its other end adapted to releasably engage the tip eyelet when the fishing rod is in a flexed disposition.
G. U.S. Pat. No. 5,109,624 by Bryan issued in 1992 for Automatic Fishing Device. This displays an automatic fishing device for suspension from tree limbs, stumps and other supports or objects and automatically hooking fish. It is characterized by a frame having an inverted T-shape and an arcuate length of tubing mounted in the frame, with both ends of the tubing terminating in spaced relationship in the base support member of the frame. An operating line is slidably disposed in the tubing and a hook is secured to one end of the operating line and a weight to the other end. A slotted trigger is mounted on the tubing support adjacent to the end of the tubing which receives the hook segment of the operating line.
H. U.S. Pat. No. 5,809,684 by Carter et al. issued in 1998 for Automatic Fishhook Setting Apparatus. This is a hook-setting apparatus comprised of a post and a telescoping stake for mounting the apparatus on the shore of a lake, river, or ocean. The hook setting apparatus is comprised of a trigger release mechanism having a bracket mounted on the post. A trigger release mechanism comprised of a pin and a trigger release lever are secured to a fishing line with the natural flexibility of a fishing pole holding a trigger pin in the trigger release lever.
I. U.S. Pat. No. 6,050,019 by Anderson issued in 2000 for a Rod and Reel Holder with Automatic Hook Setter. This invention holds a fishing rod and reel in a variety of situations and automatically sets the fishing hook when a fish strikes the baited hook or lure. Adapters hold the vertical stand either on a pond bank, a boat or dock rail, or dock flooring. The vertical stand pivotally supports a rod and reel holder, which is configured to hold the fishing tackle securely and without damage. The fishing line is looped under the trigger lever, which is raised and rotated by the pull on the fishing line when a fish strikes the bait. The catch arm is released as the trigger lever is lifted. The rod and reel holder are spring loaded and pivots around the support point when the catch arm is released, thus snapping to a more upright position, which action sets the hook.
J. U.S. Pat. No. 7,162,828 by Marina in 2007 for an Automatic Fishing Device. An automatic fishing device is comprised of a fishing rod support for supporting a fishing rod. A spring-loaded fishing line puller is movably attached to the support and arranged to engage a portion of the line along the fishing rod. An actuating arm hinged to a fixed position on the support is attached to a forward end of the fishing rod. A latch connected to the actuating arm is arranged to secure the puller in a cocked position under spring loading. When the fishing line is pulled by a fish, the forward end of the fishing rod is tilted down to tilt the actuating arm downward. The latch is moved by the actuating arm to disengage from the line puller, which is quickly moved by a spring away from the fishing rod to momentarily retract the fishing line and set the fishhook in the fish.
K. U.S. Pat. No. 7,503,140 by Polzin issued in 2009 for an Automatic Fishing Hook Setting Device and Method of Use. It details a fishing device that attaches to a fishing pole so as to automatically set the fishhook when a fish takes the bait while the pole is unmanned. The device includes a retainer and a cord. The cord extends between a lower end of the pole and the retainer. A hook on the retainer mounts onto the tip eye of the pole so as to bend the pole into a flexed position.
L. U.S. Pat. No. 7,849,629 by Adcock issued in 2010 for an Automatic Fishhook Setter Apparatus and Method. This provides an automatic fishhook setter apparatus includes a trigger with a length and a center line, where the trigger includes a cocking rod hole, a tensioner hole, and a line hole and where at least the cocking hole and the tensioner hole are located off of the center line. A cocking rod is connected with the cocking rod hole and a tensioner is connected with the tensioner hole.
M. U.S. Pat. No. 8,476,437 by Roh issued in 2013 for an Automatic Hook Setting Device. The invention is directed to an automatic hook setter having a housing with an internal cavity having an opening with several notches. An eyelet trigger is attached to the housing by a pivot in the internal cavity and has a first end and a second end. The second end extends outside of the housing. A fishing line trigger is pivotally attached to the housing and has a first position and a second position. In the second position the fishing line trigger overlaps the notches to form a number of slots. A lanyard is attached to the housing. One end of the lanyard has cord clip.
N. U.S. Pat. No. 9,426,972 by Nichols issued in 2016 for a Self-hook Setting Rod Holder. This is an automatic hook setting rod holder is comprised of a flat base supporting a rod holder that rotates vertically upward when a fish strikes a hook, thereby setting the hook. A torsion spring and bar assembly lies under the rod holder and is held in a pre-strike position by a trigger rod. The trigger rod is connected to the base and has a bearing surface to hold the loaded torsion spring and bar assembly in a pre-strike position. The trigger rod has a bent end to receive and hold the fishing line before a fish strike. Once a fish strikes, tension on the fishing line pulls and rotates the trigger rod away from the torsion spring and bar assembly, thereby releasing it and causing it to contact the rod holder, which in turn causes it to rotate upward and sets the hook in the fish's mouth.
O. Patent Application No. US 2006/0064918 by Schnur submitted and published in 2006 for an Automatic Fishing Device. This teaches an automatic fishhook setting device having a main body portion, fishing pole retention latch and a strike sensor arm. The fishing pole retention latch has an abutment surface and is pivotally attached to the main body portion. The strike sensor arm is pivotally attached to the main body portion and has an abutment surface and a fishing line holder. The abutment surface of strike sensor arm and the abutment surface of the fishing pole retention latch cooperate to prevent the fishing pole retention latch from pivoting in at least one direction when the strike sensor arm is located in a first position. The abutment surfaces do not cooperate to prevent rotation of the fishing pole retention latch when the strike sensor arm is in a second position.
P. Patent Application No. US 2008/0134563 submitted then published in by Gunter in 2008 for an Automatic Fishhook Setter. This shows a fishing device that automatically sets a fishing hook within the mouth of a fish when the fish bites on the hook. The automatic fishhook setting device comprises a housing, a fishing pole holder, a trigger mechanism, and a biasing mechanism. The fishing pole holder is adapted to hold a fishing pole therein. The trigger mechanism is configured to hold the fishing pole holder in a first position until a fish bites the fishing hook. When a fish bites the fishing hook, the trigger mechanism is disengaged and the biasing mechanism causes the fishing pole to quickly rotate to a second position, thereby setting the fishing hook within the mouth of the fish. An alarm mechanism is also disclosed. The alarm mechanism notifies a user when a fish has been caught using the automatic fishhook setting device.
Q. Patent Application No. US 2010/0236137 by Roh submitted then published in 2010 for an Automatic Hook Setting Device. It teaches an automatic hook setter having a housing with an internal cavity having an opening with several notches. An eyelet trigger is attached to the housing by a pivot in the internal cavity and has a first end and a second end. The second end extends outside of the housing. A fishing line trigger is pivotally attached to the housing and has a first position and a second position. In the second position the fishing line trigger overlaps the notches to form a number of slots. A lanyard is attached to the housing. One end of the lanyard has cord clip.
R. Patent Application No. US 2011/0219661 by Remington sent and published in 2011 for a Fishing Trigger Device. This provides a fishing trigger device alerts the fisherman of a fish bite and at the same time releases the fishing line to offer sufficient slack line for the fish to swallow the bait. The fishing trigger device includes a holder adapted to be inserted into a ground, the holder including a one-piece device including a container and a pointed end and a trigger supported by the container, the trigger adapted to secure a fishing line prior to a fish bite, the trigger adapted to release the fishing line after the fish bite.
S. Patent Application No. US 2012/0102812 by Payne published in 2012 for a Strike-Setting Assembly for Use with an Unmanned Fishing Rod. This is a strike-setting assembly for an unmanned fishing rod including a hook-setting device carried by a fishing pole holder is provided. The hook-setting device includes a tether and an efficient, reliable mechanical trigger assembly including multiple magnets that permit easy, sensitive, multiple adjustments in multiple increments. The fishing pole holder is suitable for retaining the hook-setting device and for holding the rod in a manner providing resistance to the upward tension on the back handle portion of the fishing rod applied by the hook-setting device engaged on the front of the fishing rod.
T. Patent Application No. US 2014/0215892 by Barber published in 2014 for a Hook Setting Trigger. This is a hook setting trigger is a device that automatically sets a fishing hook. The hook setting trigger utilizes a fisherman's existing or preferred fishing rod set up. The hook setting trigger is additionally able to adjust the sensitivity of the trigger. The hook setting trigger accomplishes this through the use of an elongated body, a line catch, a tension adjuster, an eyelet mount. The device functions complimentarily with a stabilizing base to retain a fishing rod and an anchored tether. The fishing rod is flexed, and the hook setting trigger is mounted to the eyelet of the fishing rod. The baited fishing line is operatively coupled to the trigger and then positioned in the water. Upon receiving a tug on the fishing line from a biting fish, the hook setting trigger is detached, and the elasticity of the fishing rod tugs the fishing line and sets the hook.
U. Patent Application No. US 2016/0165870 by Nichols published in 2016 for a Self-Hook Setting Rod Holder. Shown is an automatic hook setting rod holder is comprised of a flat base supporting a rod holder that rotates vertically upward when a fish strikes a hook, thereby setting the hook. A torsion spring and bar assembly lies under the rod holder and is held in a pre-strike position by a trigger rod. The trigger rod is connected to the base and has a bearing surface to hold the loaded torsion spring and bar assembly in a pre-strike position. The trigger rod has a bent end to receive and hold the fishing line before a fish strike. Once a fish strikes, tension on the fishing line pulls and rotates the trigger rod away from the torsion spring and bar assembly, thereby releasing it and causing it to contact the rod holder, which in turn causes it to rotate upward and sets the hook in the fish's mouth.
V. A Design Pat. No. D750,734 by Brackett Sr., published in 2016 for a Fishhook Setting Device. This claims the ornamental design for a fishhook setting device, as shown, and described.

As can be observed, none of the prior art has anticipated or caused one skilled in the art of fishing devices used to set hooks that shows or reveals this new invention by Sheets to be seen as obvious to a person skilled in the ordinary art of the sport fishing industry. The hook setting device for fishermen called a Guard Dog provides an answer to the simple and consistent way to set a hook under an almost limitless setting of the tension cord to reflect the bite or force the fish will exert when taking the hook. The force can range from a partial ounce to several pounds based on the location of the tension cord on the Guard Dog device. This adjustment allows a nearly limitless setting for the type of fishing desired, the size of the fish, the type of pole and tackle, and the impact of the river current of sea waves on the hook and tackle. The new invention permits these variances to be accounted for in the device setting to permit the reaction and setting of the hook to occur under the desired bite and pull of the fish and not the influence of the current/waves or resistance of the pole and tackle.

### SUMMARY OF THE INVENTION

This invention is a special hook setting device for fishermen called a Guard Dog for various fishing venues. Taught here are the ways a special hook setting device for fishermen called a Guard Dog can be used to assist various users in other venues to help catch fish by setting the hook into a fish's mouth when it takes the hook or bites/pulls on the hook and bait.

The preferred embodiment of a special hook setting device for fishermen called a Guard Dog made of a durable material/coating and comprised of: (a) a trigger body with a nose and a mouth; (b) a tension string with two opposite ends; (c) a means to slidably fasten the tension string at a first end to the trigger body; and (d) a means to removably fasten the tension string at a second and opposite end to a fixed point wherein a fishing pole with an eyelet at an end opposite to a reel is removably and spring ably fastened to the fishing pole by placing the nose into the eyelet and wherein the fishing line is wrapped onto the trigger body whereby the fishing pole is held in an arched position by a user until a fish pulls on a hook which is attached to the fishing line and which dislodges the nose from the eyelet thereby releasing the rod and creates a spring force that immediately translates to a line force and thereby sets the hook into a mouth of the fish. Alternatively, a special hook setting device for fishermen called a Guard Dog made of a durable material/coating and comprised of: (a) a trigger body with a nose, a mouth, a body, a tail, a bend, and an extension stub—wherein the nose is comprised of a rounded portion of the nose whereby the rounded portion facilitates entry of nose into fishing line eyelet and wherein the body is further comprised of an aperture/ring, an inside perimeter of aperture/ring, an outside perimeter of aperture/ring, an external surface to “grip” a tension knot, and a set of indicator marks on the external surface; (b) a tension string with two opposite ends; (c) a means to slidably fasten the tension string at a first end to the trigger body; and (d) a means to removably fasten the tension string at a second and opposite end to a fixed point wherein a fishing pole with an eyelet at an end opposite to a reel is removably and spring ably fastened to the fishing pole by placing the nose into the eyelet and wherein the fishing line is wrapped onto the trigger body whereby the fishing pole is held in an arched position by a user until a fish pulls on a hook which is attached to the fishing line and which dislodges the nose from the eyelet thereby releasing the rod and creates a spring force that immediately translates to a line force and thereby sets the hook into a mouth of the fish.

The newly invented special hook setting device for fishermen called a Guard Dog can be manufactured at low volumes by very simple means and in high volume production by more complex and controlled systems.

### Objects and Advantages

There are several objects and advantages of the special hook setting device for fishermen called a Guard Dog. There are currently no known automatic hook setting devices that are effective at providing the objects of this invention. The special hook setting device for fishermen called a Guard Dog has various advantages and benefits:

| Item | Advantages |
|---|---|
| 1 | The Trigger sensitivity adjustment is made by sliding |
| | the tension cord and not by moving the fishing line |
| 2 | Many settings from heavy release (multiple pounds) to |
| | very light release (less than an ounce) and anywhere |
| | in between. Release force nearly unlimited per the |
| | multiple settings. Virtually a micro-setting ability |
| | from more than a pound to a few ounces, to fractions |
| | of an ounce. |
| 3 | Universal design that allows it to fit most fishing |
| | rods with different pole lengths, line weights, and |
| | pole eyelets. |
| 4 | Simple to adjust tension and release force by sliding |
| | tension knot from light to heavy and anywhere in |
| | between |
| 5 | Fast to install onto the rod eyelet and the fishing |
| | line is easily placed into the fishing line groove |
| 6 | No counterweight balance required |
| 7 | Compact size fits easily into most tackle boxes or |
| | pockets—i.e., convenient, and portable |
| 8 | No tools required to attach the Guard Dog to the |
| | fishing rod |
| 9 | Inexpensive cost |
| 10 | Uses known processes and materials to manufacture |
| | the Guard Dog |
| 11 | Few component parts- no springs, bearings, or small |
| | component parts to wear out and is not a complex |
| | design |
| 12 | Works with different rod holders and tension cord |
| | security means/fixed points/stakes/tie-offs |
| 13 | Better and adjustable trigger sensitivity. Reaction |
| | time to set the hook is based on the snap of trigger |
| | not a fisherman's/human's reaction time. Adjustable |
| | to compensate for river currents and live baits. |

Finally, other advantages and additional features of the present special hook setting device for fishermen will be more apparent from the accompanying drawings and from the full description of the device. For one skilled in the art of fishing and automatic hook setting devices, it is readily understood that the features shown in the examples with this product are readily adapted to other types of hook setting devices and accessories for fishing systems and devices.

### DESCRIPTION OF THE DRAWINGS—FIGURES

The accompanying drawings, which are incorporated in and constitute a part of this specification, illustrate an embodiment of the special hook setting device for fishermen called a Guard Dog that is preferred. The drawings together with the summary description given above and a detailed description given below serve to explain the principles of the Automatic Hook Setting device. It is understood, however, that the special hook setting device for fishermen called a Guard Dog is not limited to only the precise arrangements and instrumentalities shown.

FIGS. 1 A through 1 C are sketches of the general special hook setting device for fishermen called a Guard Dog.

FIGS. 2 A through 2 F are sketches of the general automatic hook setting device from various views and with components and features noted.

FIGS. 3 A through 3 C are closeup views of the adjustment area for the tension cord with the features shown from a top view.

FIGS. 4 A through 4 D are even more sketches of the automatic hook-setting device with various types of manufacturing and materials noted.

FIGS. 5 A and 5 B are sketches of a special hook setting device for fishermen called a Guard Dog with configurations showing light and heavy tension settings of the tension cord.

FIGS. 6 A through 6 G are sketches of special hook setting device for fishermen called a Guard Dog in operation from the set position, sprung position, and the caught fish position as well as tie-off options for the tension cords.

FIGS. 7 A through 7 F are sketches of prior art for automatic hook-setting devices used in fishing.

### DESCRIPTION OF THE DRAWINGS—REFERENCE NUMERALS

The following list refers to the drawings:

TABLE B
Reference numbers

| Ref # | Description |
|---|---|
| 30 | special hook setting device 30 for fishermen called a |
| | Guard Dog |
| 33 | isometric view 33 of special hook setting device for |
| | fishermen called a Guard Dog 30 |
| 34 | sheet or plate formed version 34 special hook setting |
| | device 30 for fishermen called a Guard Dog |
| 35 | wire or rod formed version 35 special hook setting |
| | device 30 for fishermen called a Guard Dog |
| 39 | trigger unit 39 comprised of body 40 and tail 60 and |
| | their components |
| 40 | body 40 at one end of the special hook setting device |
| | 30 |
| 41 | separate clip piece 41 (optional) to mechanically |
| | grip body and slidably retain tension knot 55 at set |
| | indicator mark 46 on body 40 |
| 42 | aperture/ring 42 of body 40 |
| 43 | inside perimeter 43 of aperture/ring 42 |
| 44 | outside perimeter 44 of aperture/ring 42 |
| 45 | external surface 45 of body 40 surface can be |
| | knurled, rough/sand finish-like, ridged, or coated |
| | to better “grip” tension knot |
| 46 | indicator marks 46 on external surface 45 of body 40 |
| 46L | indicator mark “L” 46L, TC1 meaning light release |
| TC1 | force F1, mark being farthest from mouth 48 and nose |
| | 49 |
| 46H | indicator mark “H” 46H, TC2 meaning heavy release |
| TC2 | force F2, mark being nearest to mouth 48 and nose 49 |
| 46MS | Multiple setting indicators 46MS micro set Tension |
| | String 50 for adjustable trigger sensitivity |
| 47 | rounded portion 47 of nose 49 tapered/sloped to |
| | permit easy entry of nose 47 into fishing line eyelet |
| | 95 |
| 48 | mouth 48 |
| 49 | nose 49 |
| 50 | tension string 50, cord, line, small diameter rope |
| 55 | means for connecting 55 (tension knot) tension string |
| | 50 to body 40—overhand knot, anchor hitch knot, |
| | fisherman's hitch, clove hitch, square knot, studding |
| | sail knot |
| 58 | means for connecting 58 tension string 50 fixed point |
| | 59—overhand knot, anchor hitch knot, fisherman's |
| | hitch, clove hitch, square knot, studding sail knot |
| 58A | tension string slip pad 58A (optional) with apertures |
| | 58B for tension cord 50 |
| 59 | fixed point 59 onto one's fishing rod holder 59A, on |
| | to the rod holder ground stake, on a fishing reel |
| | handle, on a separate ground stake 598, on a tree |
| | branch or limb 59C, or onto something secure on a |
| | boat 59D |
| 60 | split tail 60 with two sides 60A and 60B at an end |
| | opposite the end of the body 40 of special hook |
| | setting device 30 |
| 62 | fishing line groove or notch between two sides 60A |
| | and 60B of split tail 60 |
| 63 | tail 63 |
| 64 | bend 64 between tail 63 and extension stub 65 |
| 65 | extension stub 65 of tail 63 after bend 64 and before |
| | split tail 60 |
| 90 | rod and reel 90 |
| 91 | rod, pole 91 made of various traditional materials |
| | such as metal, plastics, fiberglass, and composite |
| | materials |
| 92 | reel, spin cast, line actuator 92 |
| 93 | fishing reel handle 93 |
| 95 | fishing line eyelet 95 |
| 96 | fishing pole handle 96 |
| 97 | rod holder 97 for fishing pole handle 96 |
| 98 | hook 98 on line 99 to be set |
| 99 | fishing line 99 filament of typical materials and |
| | sized as pound-test for various weights to be sought |
| | and break strength of line |
| 100 | operator, user, and fisherman 100 |
| 110 | set-up 110 of the special hook setting device 30 for |
| | fishermen called a Guard Dog |
| 112 | spring force 112 on fishing pole 91 when released |
| 114 | spring force 114 on fishing line 99 from pole 91 when |
| | released |
| 115 | sprung position 115 |
| 118 | caught fish position 118 |
| 120 | water level 120 of lake, sea, ocean, river |
| 150 | fish 150 |
| 160 | reference US quarter dollar 160 shown for approximate |
| | size comparison |
| A | Light setting A—interference of nose 49 with |
| | minimal entrance into eyelet 95 |
| B | Heavy setting B—interference of nose 49 with |
| | maximum entrance into eyelet 95 |
| F | release force F |
| 300 | Prior art 300 App US 2008/0134563 AUTOMATIC FISH |
| | HOOKSETTER—Gunter 2008 |
| 310 | Prior art 310 App US 2006/0064918 AUTOMATIC |
| | FISHING DEVICE—Schnur 2006 |
| 320 | Prior art 320—App US 2010/0236127 AUTOMATIC |
| | HOOKSETTING DEVICE—Roh 2010 |
| 330 | Prior Art 330—App US 2014/0215892 HOOKSETTING |
| | TRIGGER—BARBER 2014 |
| 340 | Prior Art 340—App US2012/0102812 STRIKE-SETTING |
| | ASSEMBLY FOR USE WITH AN UNMANNED- |
| | FISHING ROD—Payne 2012 |
| 350 | Prior Art—U.S. Pat. No. 3,914,894 AUTOMATIC |
| | FISHHOOK SETTER—Kobza 1975 |

### DETAILED DESCRIPTION OF PREFERRED EMBODIMENT

The present development is a special hook setting device for fishermen called a Guard Dog. The device relates to fishing accessories and more particularly, relates to a fishhook setting apparatus that will automatically and quickly set a hook when a fish bites. Particularly this product is related to an automatic, self-setting quick release rod holder that automatically sets a fishing hook in a fish's mouth upon a fish strike and a strike-setting assembly for use with an unmanned fishing rod including a hook-setting device carried by a fishing pole holder, and more particularly, to a hook-setting device. The device relates to a device or tool to automatically set a hook when fishing and the pole is unmanned. Finally, the device relates to fish pole holders of the type including an automatic fishhook setter and relates to fishing tackle and particularly to mechanism associated with a rod or pole for automatically setting the hook when a fish strikes.

The advantages for the special hook setting device 30 for fishermen called a Guard Dog are listed above in the introduction. Succinctly the benefits are that the device:
A. The Trigger sensitivity adjustment is made by sliding the tension cord and not by moving the fishing line;
B. Many settings from heavy release (multiple pounds) to very light release (less than an ounce) and anywhere in between. Release force essentially unlimited per the setting. Virtually a micro-setting ability from more than a pound to a few ounces, to fractions of an ounce;
C. Universal design that allows it to fit most fishing rods with different pole lengths, line weights, and pole eyelets. design for attachments to fit different lines weights and pole eyelets;
D. Simple to adjust tension and release force by sliding tension knot from light to heavy and anywhere in between;
E. Fast to install onto the rod eyelet the and the fishing line is easily placed into the fishing line groove;
F. No counterweight balance required; G. Compact size fits easily into most tackle boxes or pockets—i.e., convenient, and portable;
H. No tools required to attach the Guard Dog to the fishing pole;
I. Inexpensive cost;
J. Uses known processes and materials to manufacture;
K. Few component parts—no springs, bearings, or small component parts to wear out and is not a complex design;
L. Works with different rod holders and tension cord security means/fixed points/stakes/tie-offs; and
M. Better and adjustable sensitivity. Reaction time to set the hook is based on the snap of trigger not a fisherman's/human's reaction time.

The preferred embodiment of the special hook setting device 30 for fishermen called a Guard Dog made of a durable material/coating and comprised of: (a) a trigger body 39 with a nose 49 and a mouth 48; (b) a tension string 50 with two opposite ends; (c) a means 55 to slidably fasten the tension string 50 at a first end to the trigger body 39; and (d) a means 58 to removably fasten the tension string at a second and opposite end to a fixed point 59 wherein a fishing pole 90 with an eyelet 95 at an end opposite to a reel is removably and spring ably fastened to the fishing pole 91 by placing the nose 48 into the eyelet 95 and wherein the fishing line 99 is wrapped onto the trigger body 39 whereby the fishing pole is held in an arched position by a user 100 until a fish 150 pulls on a hook 98 which is attached to the fishing line 99 and which dislodges the nose 49 from the eyelet 95 thereby releasing the rod 91 and creates a spring force that immediately translates to a line force 114 and thereby sets the hook 98 into a mouth of the fish 150. Alternatively, a special hook setting device 30 for fishermen called a Guard Dog made of a durable material/coating and comprised of: (a) a trigger body 39 with a nose 49, a mouth 48, a body 40, a tail 63, a bend 64, and an extension stub 65—wherein the nose is comprised of a rounded portion 47 of the nose 49 whereby the rounded portion 47 facilitates entry of nose 49 into fishing line eyelet 95 and wherein the body is further comprised of an aperture/ring 42, an inside perimeter 43 of aperture/ring 42, an outside perimeter 44 of aperture/ring 42, an external surface 45 to “grip” a tension knot 55, and a set of indicator marks 46 on the external surface 45; (b) a tension string 50 with two opposite ends; (c) a means 55 to slidably fasten the tension string 50 at a first end to the trigger body 39; and (d) a means 58 to removably fasten the tension string at a second and opposite end to a fixed point 59 wherein a fishing pole 90 with an eyelet 95 at an end opposite to a reel is removably and spring ably fastened to the fishing pole 91 by placing the nose 48 into the eyelet 95 and wherein the fishing line 99 is wrapped onto the trigger body 39 whereby the fishing pole is held in an arched position by a user 100 until a fish 150 pulls on a hook 98 which is attached to the fishing line 99 and which dislodges the nose 49 from the eyelet 95 thereby releasing the rod 91 and creates a spring force that immediately translates to a line force 114 and thereby sets the hook 98 into a mouth of the fish 150.

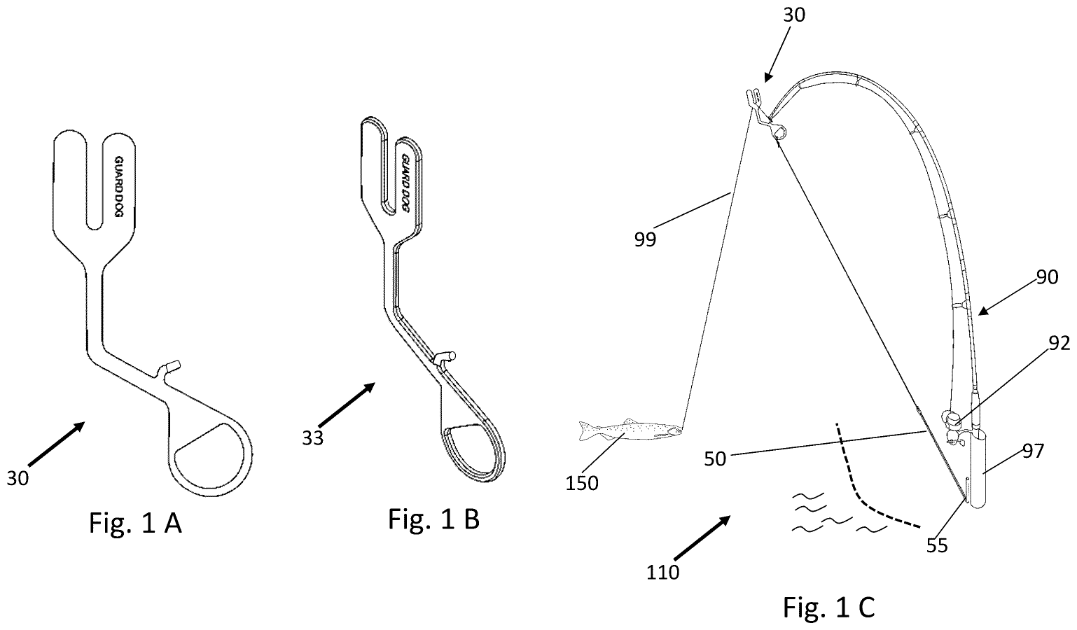

There is shown in FIGS. 1-7 a complete description and operative embodiment of the special hook setting device for fishermen called a Guard Dog. In the drawings and illustrations, one notes well that the FIGS. 1-7 demonstrate the general configuration and use of this product. The various example uses are in the operation and use section, below.

The accompanying drawings, which are incorporated in and constitute a part of this specification, illustrate an embodiment of the special hook setting device for fishermen called a Guard Dog that is preferred. The drawings together with the summary description given above and a detailed description given below serve to explain the principles of the Special Hook Setting device 30. It is understood, however, that the device 30 is not limited to only the precise arrangements and instrumentalities shown. Other examples of automatic hook setting devices and systems for fishing are still understood by one skilled in the art of fishing and hook setting devices to be within the scope and spirit shown here.

FIGS. 1 A through 1 C are sketches of the general special hook setting device 30 for fishermen called a Guard Dog. Here in these sketches are seen: a special hook setting device 30 for fishermen called a Guard Dog; an isometric view 33 of special hook setting device for fishermen called a Guard Dog 30; a tension string 50, cord, line, small diameter rope; a means for connecting 55 (tension knot) tension string 50 to body 40; a rod and reel 90; a reel, spin cast, line actuator 92; a rod holder 97 for fishing pole handle 96; and a fishing line 99.

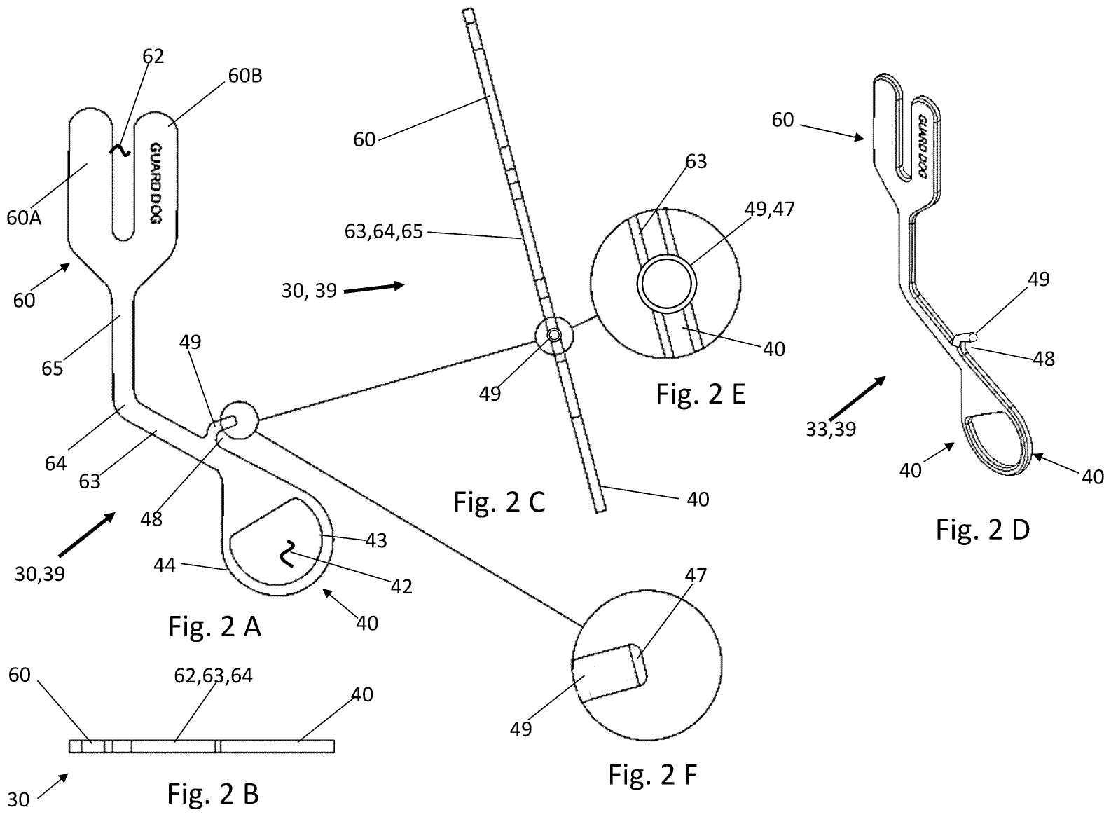

FIGS. 2 A through 2 F are sketches of the general automatic hook setting device from various views and with components and features noted. The details, components, and features in these sketches include: a special hook setting device 30 for fishermen called a Guard Dog; an isometric view 33 of special hook setting device for fishermen called a Guard Dog 30; a trigger unit 39 comprised of body 40 and tail 60 and their components; a body 40 at one end of the special hook setting device 30; an aperture/ring 42 of body 40; an inside perimeter 43 of aperture/ring 42; an outside perimeter 44 of aperture/ring 42; a rounded portion 47 of nose 49 tapered/sloped to permit and facilitate easy entry of nose 49 into fishing line eyelet 95; a mouth 48; a nose 49; a split tail 60 with two sides 60A and 60B at an end opposite the end of the body 40 of special hook setting device 30; a groove or notch between two sides 60A and 60B of split tail 60; a tail 63; a bend 64 between tail 63 and extension stub 65; and an extension stub 65 of tail 63 after bend 64 and before split tail 60.

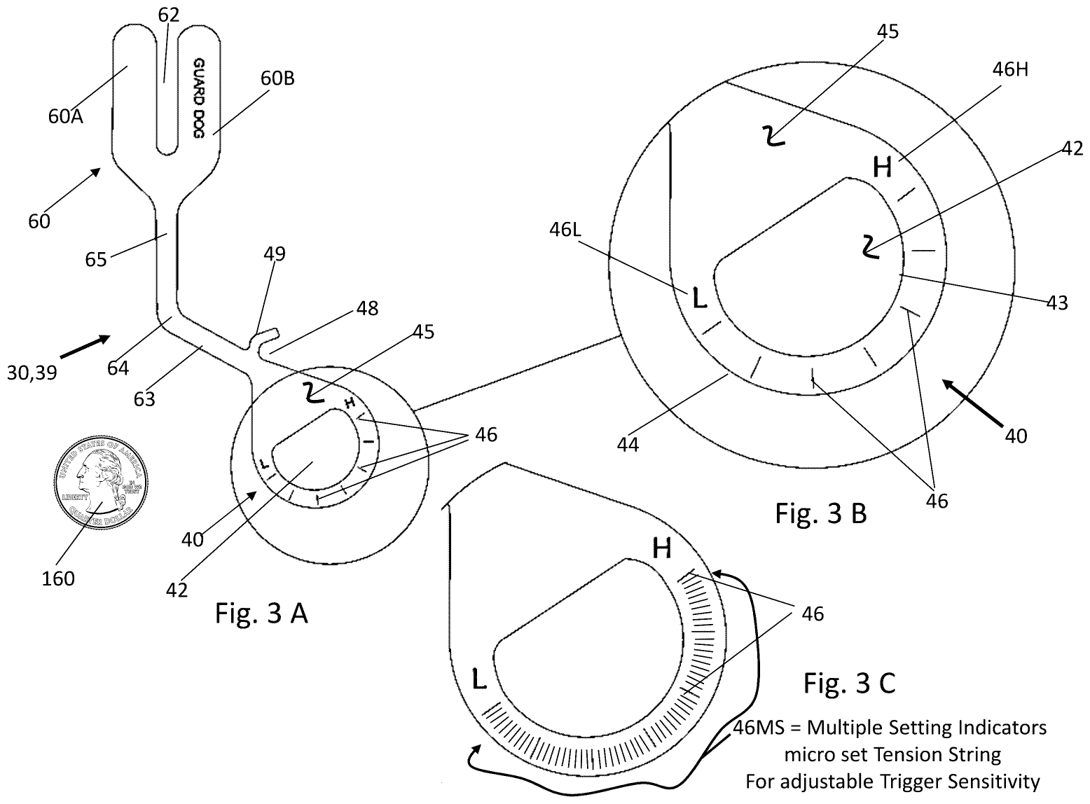

FIGS. 3 A through 3 C are closeup views of the adjustment area for the tension cord with the features shown from a top view. Portrayed in this top view and exploded view are: a special hook setting device 30 for fishermen called a Guard Dog; a trigger unit 39 comprised of body 40 and tail 60 and their components; a body 40 at one end of the special hook setting device 30; an aperture/ring 42 of body 40; an inside perimeter 43 of aperture/ring 42; an outside perimeter 44 of aperture/ring 42; an external surface 45 of body 40 surface can be knurled, rough/sand finish-like, ridged, or coated to better “grip” tension knot; an indicator marks 46 on external surface 45 of body 40 indicator mark “L” 46L, TC1 meaning light release force F1, mark being farthest from mouth 48 and nose 49; an indicator mark “H” 46L, TC2 meaning heavy release force F2, mark being nearest to mouth 48 and nose 49; a mouth 48; a nose 49; a split tail 60 with two sides 60A and 60B at an end opposite the end of the body 40 of special hook setting device 30; a groove or notch between two sides 60A and 60B of split tail 60; a tail 63; a bend 64 between tail 63 and extension stub 65; an extension stub 65 of tail 63 after bend 64 and before split tail 60; and a reference US quarter dollar 160 shown for approximate size comparison. Release of nose 49 from the eyelet 95 is not impacted by line direction/angle. It is the release force F as the line pulls through the fishing line groove 62. As the line 99 is pulled, the trigger 20 rotates and the nose 49 is dislodged from the eyelet 95 and the rod 91 snaps and the hook 98 is set. The line 99 pulls downward & rotates the nose 49 from the eyelet 95. FIG. 3 C shows how the tension cord 50 knot or means 55 slides around the infinite trigger sensitivity settings/micro set and indicator marks 46. This allows the release force F to vary in a non-limited or infinite setting and thereby permitting the cord 50 to be set at whatever release tension force F is desired. The release force counters the currents of rivers, the waves, the movement of live bait, trolling resistance, and the set point of pounds or ounces depending on the size and weight of the fish being sought after by the fisherman. The length and material of the rod can be offset as well. Multiple setting indicators 46MS micro set Tension String 50 for adjustable trigger sensitivity.

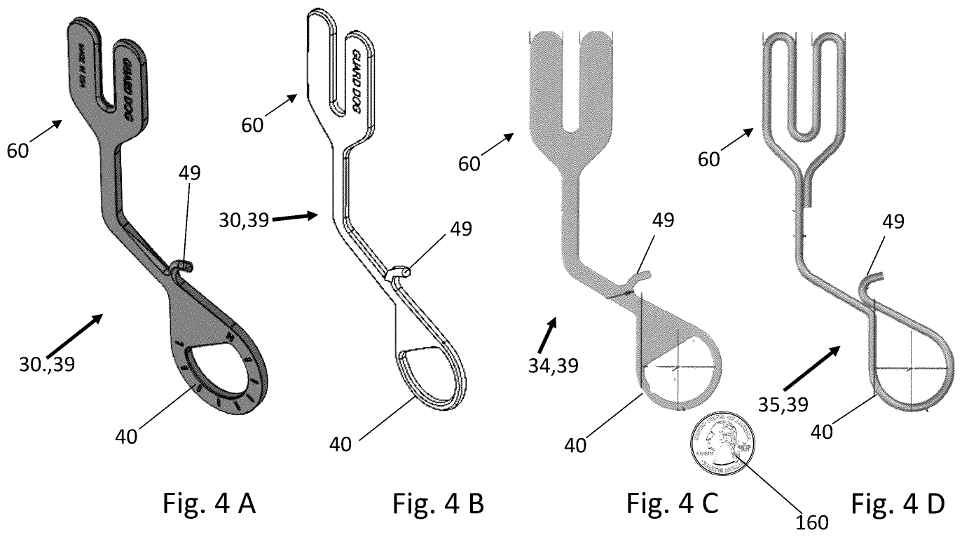

FIGS. 4 A through 4 D are even more sketches of the automatic hook-setting device with several types of manufacturing and materials noted. Shown and compared in these views are: a special hook setting device 30 for fishermen called a Guard Dog; an isometric view 33 of special hook setting device for fishermen called a Guard Dog 30; a sheet or plate formed version 34 special hook setting device 30 for fishermen called a Guard Dog; a wire or rod formed version 35 special hook setting device 30 for fishermen called a Guard Dog; a trigger unit 39 comprised of body 40 and tail 60 and their components; a body 40 at one end of the special hook setting device 30; a split tail 60 of the special hook setting device 30; and a reference US quarter dollar 160 shown for approximate size comparison.

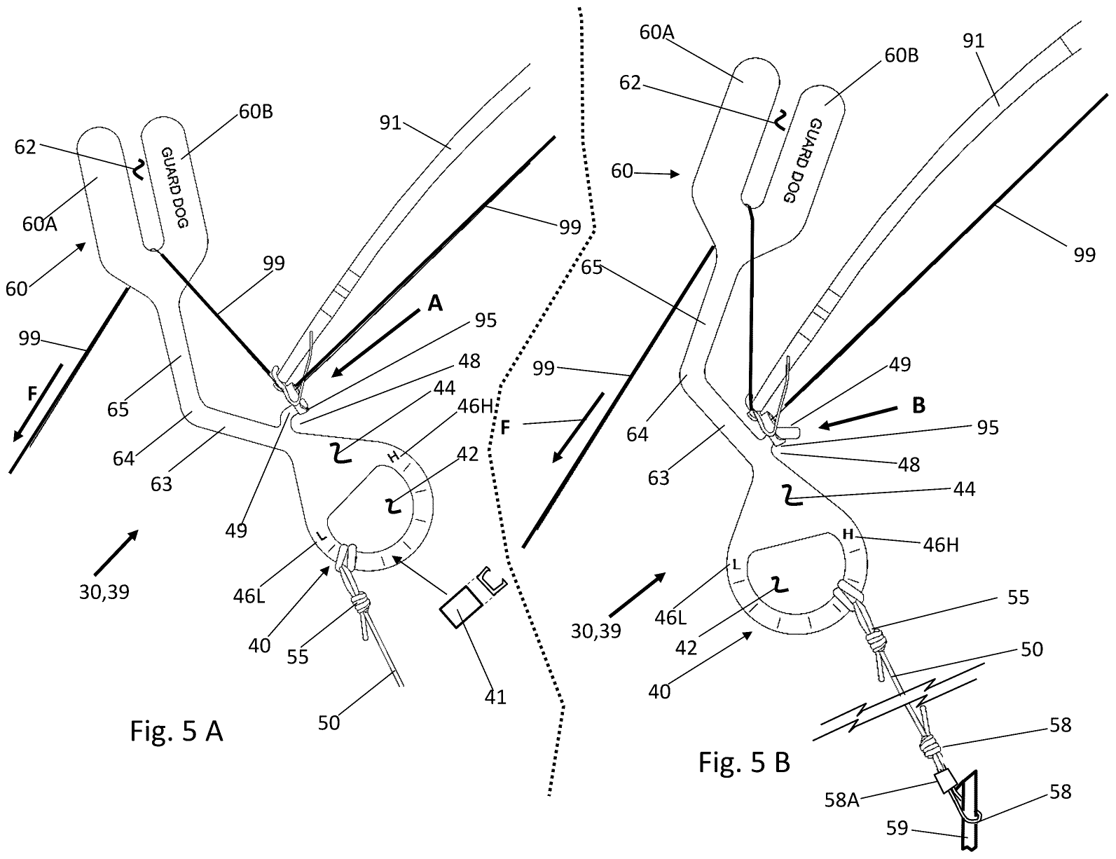

FIGS. 5 A and 5 B are sketches of a special hook setting device for fishermen called a Guard Dog with configurations showing light and heavy tension settings of the tension cord. Demonstrated here is a Light A and Heavy B setting of the device 30 with all the components and features noted. Shown here are: a special hook setting device 30 for fishermen called a Guard Dog; a trigger unit 39 comprised of body 40 and tail 60 and their components; a body 40 at one end of the special hook setting device 30; a separate clip piece 41 (optional) to mechanically grip body and slidably retain tension knot 55 at set indicator mark 46 on body 40; an aperture/ring 42 of body 40; an external surface 45 of body 40 surface can be knurled, rough/sand finish-like, ridged, or coated to better “grip” tension knot; an indicator marks 46 on external surface 45 of body 40; an indicator mark “L” 46L, TC1 meaning light release force F1, mark being farthest from mouth 48 and nose 49; an indicator mark “H” 46L, TC2 meaning heavy release force F2, mark being nearest to mouth 48 and nose 49; a mouth 48; a nose 49; a tension string 50, cord, line, small diameter rope; a means for connecting 55 (tension knot) tension string 50 to body 40—overhand knot, anchor hitch, fisherman's hitch, clove hitch, square knot, studding sail; a means for connecting 58 tension string 50 fixed point 59—overhand knot, anchor hitch, fisherman's hitch, clove hitch, square knot, studding sail; a tension string slip pad 58A (optional) with apertures 58B for tension cord 50; a fixed point; a split tail 60 with two sides 60A and 60B at an end opposite the end of the body 40 of special hook setting device 30; a groove or notch between two sides 60A and 60B of split tail 60; a tail 63; a bend 64 between tail 63 and extension stub 65; an extension stub 65 of tail 63 after bend 64 and before split tail 60; a rod, pole 91 made of various traditional materials such as metal, plastics, fiberglass, and composite materials; a fishing line eyelet 95; a fishing line 99 filament of typical materials and sized as pound-test for various weights to be sought and break strength of line; a Light setting A—interference of nose 49 with minimal entrance into eyelet 95; and a Heavy setting B—interference of nose 49 with maximum entrance into eyelet 95. The area where the tension string is attached to the body can be smooth, notched, grooved, knurled etc. to allow the tension string placement to be adjusted for the adjustable settings between A and B. There can be an optional separate part 41 that can be attached to body to move or slide tension cord/string knot 55 on the Guard Dog 30 around the body 40.

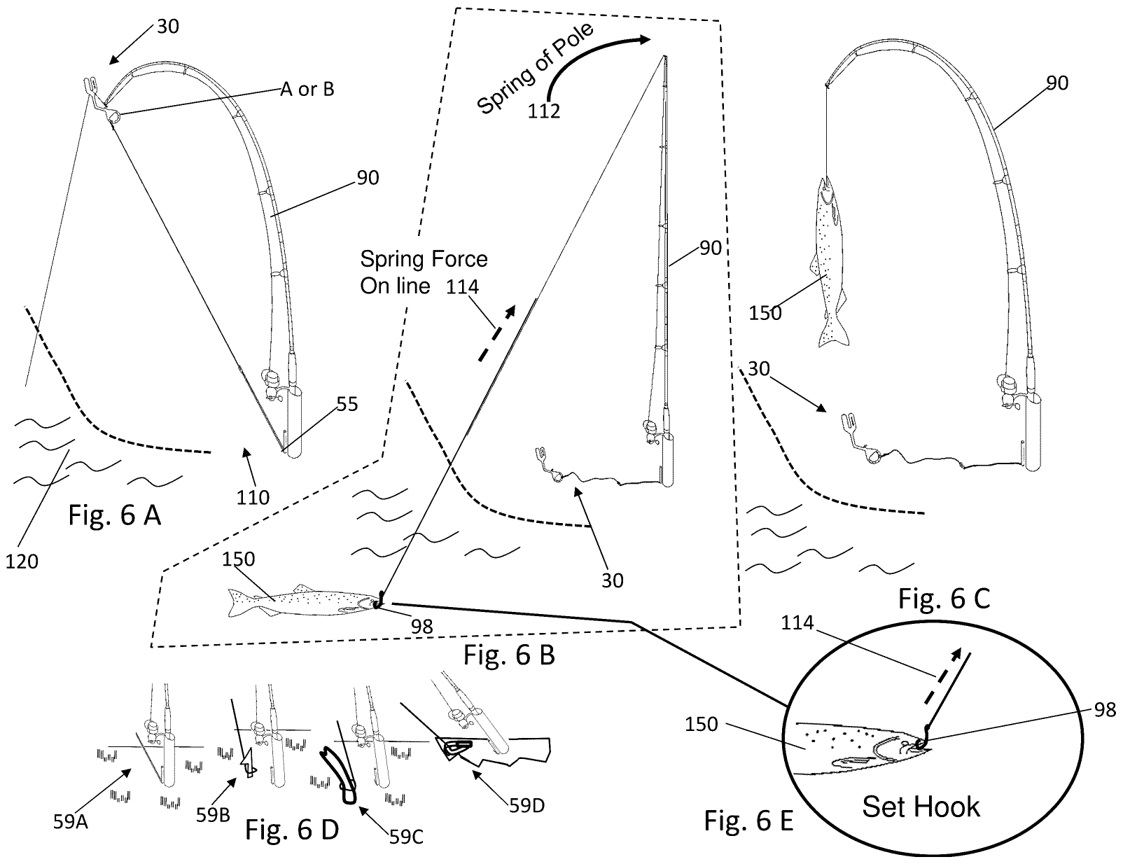

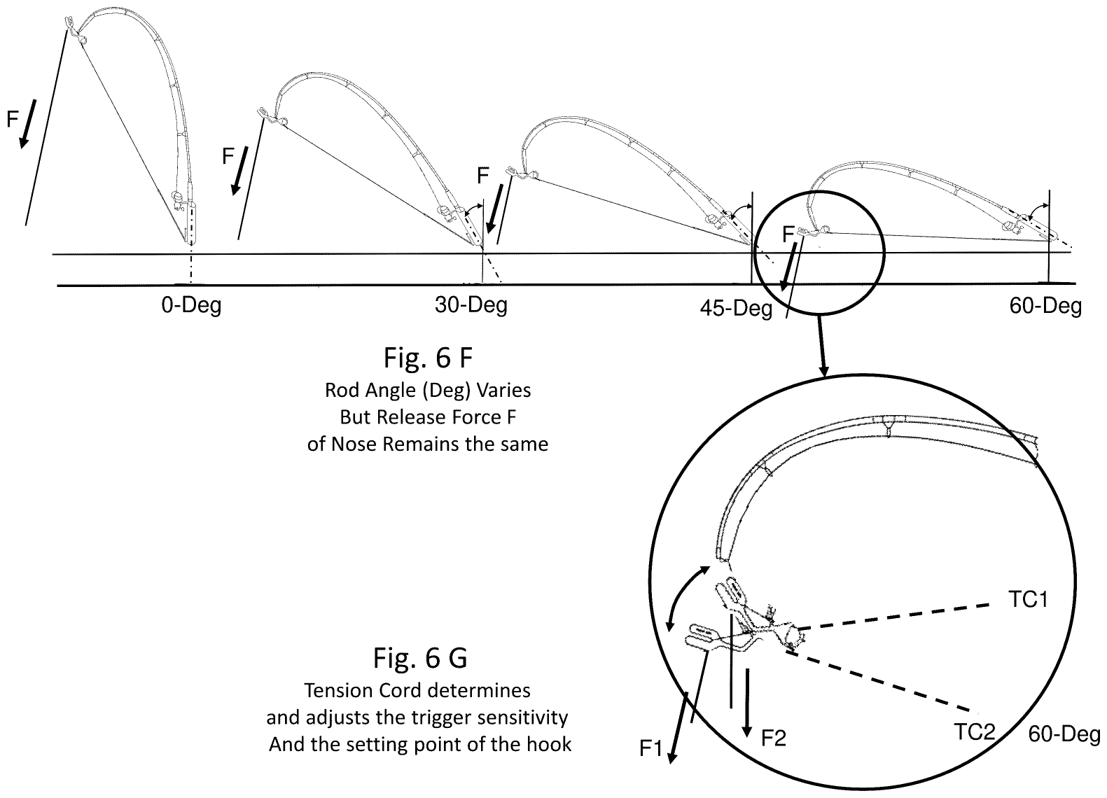

FIGS. 6 A through 6 G are sketches of special hook setting device for fishermen called a Guard Dog in operation from the set position, spring position, and the caught fish position as well as tie-off options for the tension cords. This is described in the Operation Section below.

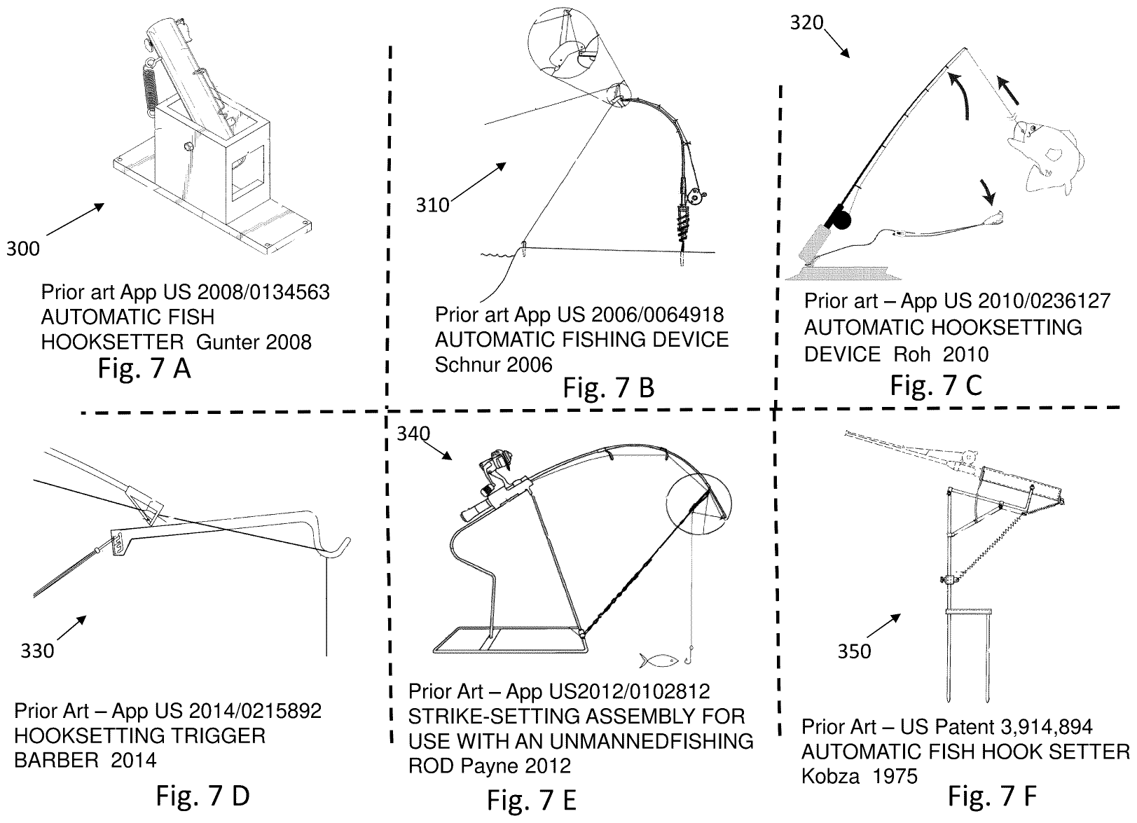

FIGS. 7 A through 7 F are sketches of prior art for automatic hook-setting devices used in fishing. Shown here are: Prior art 300 App US 2008/0134563 AUTOMATIC FISH HOOKSETTER—Gunter 2008; Prior art 310 App US 2006/0064918 AUTOMATIC FISHING DEVICE—Schnur 2006; Prior art 320—App US 2010/0236127 AUTOMATIC HOOKSETTING DEVICE—Roh 2010; Prior Art 330—App US 2014/0215892 HOOKSETTING TRIGGER—BARBER 2014; Prior Art 340—App US2012/0102812 STRIKE-SETTING ASSEMBLY FOR USE WITH AN UNMANNEDFISHING ROD—Payne 2012; and Prior Art—U.S. Pat. No. 3,914,894 AUTOMATIC FISHHOOK SETTER—Kobza 1975. As shown, none of these render the Sheets device with the tension cord adjustment means as anticipated nor obvious.

Materials for producing the main body are varied durable materials. It can be metal—steel, steel alloy, pot metal, aluminum, brass, and others; it can be a thermoplastic or thermoset plastic/polymer material—nylon, reinforced nylon, urethane, polyvinyl chloride (PVC), Polypropylene Plastic Type (PP), Acrylonitrile-Butadiene-Styrene (ABS), and others; and it can be a composite material.

There are various means to produce and manufacture the special hook setting device for fishermen called a Guard Dog. The main body can be stamped, laser cut, molded, cast, and formed from rods and wire. The guard dog can be made of assorted colors. If the durable material is metal, it can have coatings including but not limited to paint, powder coat, anodizing, plated (chrome and zinc), and clear coat acrylics.

The details mentioned here are exemplary and not limiting. Other specific components and manners specific to describing a special hook setting device 30 for fishermen called a Guard Dog may be added as a person having ordinary skill in the field of the art of automatic hook setting devices and their uses.

### Operation of the Preferred Embodiment

The special hook setting device 30 for fishermen called a Guard Dog has been described in the above embodiment. The manner of how the device operates is described below. One notes well that the description above and the operation described here must be taken together to fully illustrate the concept of the Special Automatic hook setting device 30. The preferred embodiment of the special hook setting device for fishermen called a Guard Dog made of a durable material/coating and comprised of: (a) a trigger body 39 with a nose 49 and a mouth 48; (b) a tension string 50 with two opposite ends; (c) a means 55 to slidably fasten the tension string 50 at a first end to the trigger body 39; and (d) a means 58 to removably fasten the tension string at a second and opposite end to a fixed point 59 wherein a fishing pole 90 with an eyelet 95 at an end opposite to a reel is removably and spring ably fastened to the fishing pole 91 by placing the nose 48 into the eyelet 95 and wherein the fishing line 99 is wrapped onto the trigger body 39 whereby the fishing pole is held in an arched position by a user 100 until a fish 150 pulls on a hook 98 which is attached to the fishing line 99 and which dislodges the nose 49 from the eyelet 95 thereby releasing the rod 91 and creates a spring force that immediately translates to a line force 114 and thereby sets the hook 98 into a mouth of the fish 150. Alternatively, a special hook setting device 30 for fishermen called a Guard Dog made of a durable material/coating and comprised of: (a) a trigger body 39 with a nose 49, a mouth 48, a body 40, a tail 63, a bend 64, and an extension stub 65—wherein the nose is comprised of a rounded portion 47 of the nose 49 whereby the rounded portion 47 facilitates entry of nose 49 into fishing line eyelet 95 and wherein the body is further comprised of an aperture/ring 42, an inside perimeter 43 of aperture/ring 42, an outside perimeter 44 of aperture/ring 42, an external surface 45 to “grip” a tension knot 55, and a set of indicator marks 46 on the external surface 45; (b) a tension string 50 with two opposite ends; (c) a means 55 to slidably fasten the tension string 50 at a first end to the trigger body 39; and (d) a means 58 to removably fasten the tension string at a second and opposite end to a fixed point 59 wherein a fishing pole 90 with an eyelet 95 at an end opposite to a reel is removably and spring ably fastened to the fishing pole 91 by placing the nose 48 into the eyelet 95 and wherein the fishing line 99 is wrapped onto the trigger body 39 whereby the fishing pole is held in an arched position by a user 100 until a fish 150 pulls on a hook 98 which is attached to the fishing line 99 and which dislodges the nose 49 from the eyelet 95 thereby releasing the rod 91 and creates a spring force that immediately translates to a line force 114 and thereby sets the hook 98 into a mouth of the fish 150.

The special hook setting device 30 for fishermen called a Guard Dog operates as follows: The angle at which the tension string 50 is attached to the body 40 controls the release/trigger setting 46H,T2 to 46L,T1; A to B and therefore adjusts the trigger sensitivity. The tension string angle controls the nose 49 depth entering the fishing rod eye tip 95 to allow the rod tip 95 to be released when the fish applies enough pressure 150 pulling on the fishing line 99 to release the nose 49 from the rod tip eyelet 95. A sliding or moveable part 41 could be attached to the body 40 to adjust the tension string 50 for the adjustable trigger settings and thus the trigger release sensitivity.

Set Up and Operation Instructions:
STEP 1—A user 100 should cast out bait, and reel in the slack. No matter what type of fishing reel 92 is used, next place the fishing rod holder 97 with the fishing rod eyes 95 “facing towards the water” 120, (similar to a spinning rod position), and the fishing rod 90 standing in a mostly. “upright” position. NOTE: The Guard Dog nose 49 is made out of a strong rod/wire or plate, and the rod eye tip 95 must be larger than the nose 49 to allow the Guard Dog to release freely from the rod tip 95 upon a fish strike.
STEP 2—Attach the bottom part or around end of the attached tension string 50, (opposite end of the Guard Dog end). This can be attached at the fixed 59 point onto one's fishing rod holder 97, on to the rod holder ground stake 59A, on a fishing reel handle 92, on a separate ground stake 59C, onto a limb or tree 59C, or onto something secure on a boat 59D to hold the attached tension line 50 firmly. See examples in FIG. 6D.
STEP 3—Adjust the tension string 50 length with the adjustable string tensioner bad 58A so the Guard Dog 30 and line 50 is originally set at approximately ⅔ the way up the fishing rod 91 length. Pull down the rod tip 95 and adjust the tension string 50 with the string tensioner 58A or knot 55 and fixed point 59 to the desired rod bend (and spring force 112 on fishing pole 91) when released that one desires (light arc to heavy bend will increase the release spring; snag: force 112 which in turn increases resistance to the hook 98 force 114 to resist and set the hook 98 in the fish 150). WARNING: DO NOT OVER BEND THE ROD TIP 95, as this could cause damage to the fishing rod 91!
STEP 4—Stand 100 to one side of the fishing rod 91. With the Guard Dog 30 in one hand, slowly bend the fishing rod tip 95 down and ace the fishing line 99 into the upper fishing line groove 62 of the Guard Dog 30 between the split tail 60 (60A and 60B in fishing line groove 62) With the fishing line 99 in place, place the nose 49 of the Guard Dog 30 into the top eye 95 of the rod tip with the Guard Dog nose 49, (and lead 47) facing inward towards the fishing rod 91. (Make sure the fishing line 99 in the rod tip eye 95 is placed on TOP of the Guard Dog nose 49 so the fishing line 99 can move back and forth freely inside the rod tip eye 95. (This will allow the rod user 100 to crank in any excess slack when needed.) If the rod tip eye is a “micro eye”, or too tight for the Guard Dog 30 to rotate in the rod ti eye freely, place the nose 49 of the Guard Dog 30 on the second eye on the fishing rod 91, This will not affect the Guard Dog 30 operation.
STEP 5—Slowly raise the fishing rod tip 95 until the Guard Dog 30 is firmly held in the mouth 48 by the attached tension string 50,
STEP 6—While holding the Guard Dog 30 securely in place, the user 100 can now set the trigger 39 setting from light L,A to a heavy H,B, (and anywhere in between). By manually sliding the attached string knot 55 on the Guard Dog 50 rearward (towards the water and “L” mark) it will create a lighter and faster trigger 39 strike setting A. Sliding the string forward, (towards the pole and “H” mark), will create a heavier trigger 39 setting B) One should use the lightest trigger 39 setting possible depending on the water current. NOTE: DO NOT SET THE ADJUSTABLE TRIGGER TOO LIGHT AS THIS CAN ACCIDENTLY CAUSE THE ROD TIP TO SWING LOOSE FROM THE GUARD DOG AND CAUSE AN UNWANTED RELEASE.

Instructions for Reflective Tape:

One can use this Guard Dog 30 as it, is, or one can paint it any color he would like! To apply the “glow in the dark” tape to the Guard Doq 30, first clean the Guard Dog with rubbing alcohol, mineral spirits, or wash with a grease cleaning dishwashing liquid and rinse with water to remove any oils or residues, and then dry completely One can now apply the glow in the dark tape to the upper “tail section” 60 of the Guard Dog. When painting, a person 100 should clean the Guard Dog 30 as previously stated, then prime and paint with the paint color of choice, After paint has fully dried, one can apply the glow in the dark tape to the upper “tail section” 60. NOTE: Place the glow in the dark tape section close to a strong light source to charge the glow in the dark tape before using.

FIGS. 6 A through 6 G are sketches of special hook setting device 30 for fishermen called a Guard Dog in operation from the set position 110, sprung position 115, and the caught fish position 118 as well as tie-off options for the tension cords. These views demonstrate and portray the use of the device 30. One can see: a special hook setting device 30 for fishermen called a Guard Dog; a means for connecting 55 (tension knot) tension string 50 to body 40—overhand knot, anchor hitch, fisherman's hitch, clove hitch, square knot, studding sail; a means for connecting 58 tension string 50 fixed point 59—overhand knot, anchor hitch, fisherman's hitch, clove hitch, square knot, studding sail; a fixed point 59 onto one's fishing rod holder 59A, on to the rod holder ground stake, on a fishing reel handle, on a separate ground stake 59B, on a tree branch or limb 59C, or onto something secure on a boat 59D; a rod and reel 90; a rod, pole 91 made of various traditional materials such as metal, plastics, fiberglass, and composite materials; a hook 98 with the resistance/set force 114; a set-up 110 of the special hook setting device 30 for fishermen called a Guard Dog; a spring force 112 on fishing pole 91 when released; a line resistance/set force 114 on fishing line 99 when released; a sprung position 115; a caught fish position 118; a water level 120 of lake, sea, ocean, river; a fish 150; a Light setting A—interference of nose 49 with minimal entrance into eyelet 95; and a Heavy setting B—interference of nose 49 with maximum entrance into eyelet 95.

FIG. 6 F demonstrate rod angles. Competition cannot angle or it the trigger immediately trips the hook 98 setting it into the fish 150. Current pull or jumping of the fish line 99 can trip theirs. With Guard Dog 30, the release of nose 49 out of the eyelet 95 is not impacted by line 99 direction/angle. The pull and release Force F on slot/fishing line groove 62 is the same and not impacted by the rod angle (here shown zero-degrees from perpendicular, 30-degrees, 45-degrees, and 60-degrees). The release force F is nearly the same regardless of the rod angle to the ground. The line 99 is pulled downward and the nose 49 is pulled from the eyelet 95. The pole 91 then snaps and the hook 98 is set. The multiple and nearly unlimited settings offer benefits. The configuration has many settings from heavy release (multiple pounds) to very light release (less than an ounce). Release force F is essentially unlimited for the experienced fishermen and the novice. This results in a virtually micro-setting scenario. One can vary the set point from more than a pound to a few ounces, or even to fractions of an ounce. This gives better sensitivity for the set point. Using the Guard Dog means that the reaction time to set the hook is automatic. The fishhook is set based on the snap of trigger and not on a fisherman's/human's reaction time. FIG. 6 G demonstrate the adjustment of the trigger body 39 by moving the position of the means for connecting 55 (tension knot) tension string 50 to a heavier release position (from 46L or T1 toward 46H or T2). The trigger body 39 rotates and allows the nose 40 to stay engaged deeply so that the line 99 is not impacted and stays deep in the fishing line groove 62, thus the line does not disengage and the device 30 stays ready to set the hook 98. The line 99 remains in about the same location as before the rotation to nearly 60 degrees from vertical.

Several different users are anticipated for the special hook setting device 30 for fishermen called a Guard Dog. As examples, and not as limitations, some users are shown in the following Table.

| ITEM | DESCRIPTION |
|---|---|
| 1 | Experienced anglers with multiple poles |
| 2 | Novice anglers with little experience |
| 3 | Children |
| 4 | Elderly |
| 5 | Physically or mentally challenged special needs persons |

Several types of fishing are anticipated for the special hook setting device 30 for fishermen called a Guard Dog. As examples, and not as limitations, some types are shown in the following Table.

| ITEM | DESCRIPTION |
|---|---|
| 1 | Still lake and pond |
| 2 | Sea and ocean with waves and tidal movement |
| 3 | River and stream with currents |
| 4 | Boat and pontoon platforms |
| 5 | Slow-trolling and surf fishing |
| 6 | Ice fishing |
| 7 | Bank and bridge fishing |

With this description it is to be understood that the special hook setting device for fishermen called a Guard Dog is not to be limited to only the disclosed embodiment of product. The features of the Special Automatic hook setting device 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications, and equivalents that come within the spirit of the disclosures described heretofore and or/defined by the following claims are desired to be protected.

What is claimed is:

1. A special hook setting device (30) for fishermen called a Guard Dog having an adjustable trigger sensitivity, made of a durable material, used for different types of fishing, and comprised of:
(a) a trigger unit (39) with a body (40), a nose (49), a mouth (48) and a tail (63) with a fishing line groove (62);
(b) a tension string (50) with two opposite ends;
(c) a means (55) to slidably fasten the tension string (50) at a first end to the trigger body (39); and
(d) a means (58) to removably fasten the tension string at a second and opposite end to a fixed point (59)
wherein a fishing pole (90) with an eyelet (95) at an end opposite to a reel is removably and spring ably fastened to the fishing pole (91) by placing the nose (48) into the eyelet (95); wherein the fishing line (99) is wrapped onto the trigger body (39) and tail (63) into the fishing line groove (62) whereby the fishing pole is held in an arched position by a user (100) until a fish (150) pulls on a hook (98) which is attached to the fishing line (99) and which dislodges the nose (49) from the eyelet (95) thereby releasing the rod (91) and creates a spring force that immediately translates to a line force (114) that sets the hook (98) into a mouth of the fish (150); wherein the adjustable trigger sensitivity results when the tension cord (50) is slidably positioned at multiple indicator marks (46) on the body (40) to correspond to a release force (F) that rotates the body (40); and wherein said release force (F) is determined by positioning the tension cord (50) at nearly unlimited marks (46) on the body (40) which directly corresponds to line force (114) to set force to the hook (98).

2. The special hook setting device (30) in claim 1 wherein the nose (49) is further comprised of a rounded portion (47) of the nose (49) whereby the rounded portion (47) facilitates entry of nose (49) into a fishing line eyelet (95).

3. The special hook setting device (30) in claim 1 wherein the body (40) is further comprised of an aperture/ring (42), an inside perimeter (43) of the aperture/ring (42), an outside perimeter (44) of the aperture/ring (42), an external surface (45) to “grip” a tension knot (55), and a set of indicator marks (46) on the external surface (45).

4. The special hook setting device (30) in claim 3 wherein the body (40) is further comprised of a separate clip piece (41) to mechanically grip the body and slidably retain a tension knot (55).

5. The special hook setting device (30) in claim 3 wherein the set of indicator marks (46) of the body (40) further comprise an indicator mark “L” (46L) meaning light release force and being farthest from the mouth (48) and the nose (49) and an indicator mark “H” (46L) meaning light release force and being nearest to the mouth (48) and the nose (49).

6. The special hook setting device (30) in claim 1 wherein the durable material is selected from the group consisting of a metal, a plastic/polymer, and a composite material.

7. The special hook setting device (30) in claim 6 wherein the metal is selected from the group consisting of steel, steel alloy, pot metal, aluminum, and brass.

8. The special hook setting device (30) in claim 7 wherein the metal is further comprised of a coating wherein the coating is selected from the group consisting of paint, powder coat, anodizing, chrome plating, zinc plating, and clear coat acrylics.

9. The special hook setting device (30) in claim 6 wherein the plastic/polymer is selected from the group consisting of nylon, reinforced nylon, urethane, polyvinyl chloride (PVC), Polypropylene Plastic (PP), and Acrylonitrile-Butadiene-Styrene (ABS).

10. The special hook setting device (30) in claim 1 wherein the means (55) is selected from the group consisting of an overhand knot, an anchor hitch knot, a fisherman's hitch, a clove hitch, a square knot, and a studding sail knot.

11. The special hook setting device (30) in claim 1 wherein the fixed point (59) is selected from the group consisting of A fishing rod holder (59A), rod holder ground stake, a fishing reel handle, a separate ground stake (59B), a tree branch and/or limb (59C), and a secured part on a boat (59D).

12. The special hook setting device (30) in claim 1 wherein the user (100) is selected from the group consisting of experienced anglers with multiple poles, novice anglers with little experience, children, elderly people, and physically or mentally challenged special needs persons.

13. The special hook setting device (30) in claim 1 wherein the different types of fishing are selected from the group consisting of still lake and pond fishing, sea and ocean fishing with waves and tidal movement, river and stream fishing with currents, boat and pontoon platform fishing, slow-trolling and surf fishing, ice fishing, and bank and bridge fishing.

14. A special hook setting device (30) for fishermen called a Guard Dog having an adjustable trigger sensitivity, made of a durable material, and comprised of:
(a) a trigger unit (39) with a body (40), a nose (49), a mouth (48), a body (40), a tail (63) with (63) a fishing line groove (62), a bend (64), and an extension stub (65) wherein the nose is comprised of a rounded portion (47) of the nose (49) whereby the rounded portion (47) facilitates entry of nose (49) into fishing line eyelet (95) and wherein the body is further comprised of an aperture/ring (42), an inside perimeter (43) of aperture/ring (42), an outside perimeter (44) of aperture/ring (42), an external surface (45) to “grip” a tension knot (55), and a set of indicator marks (46) on the external surface (45);
(b) a tension string (50) with two opposite ends;
(c) a means (55) to slidably fasten the tension string (50) at a first end to the trigger body (39); and
(d) a means (58) to removably fasten the tension string at a second and opposite end to a fixed point (59)
wherein a fishing pole (90) with an eyelet (95) at an end opposite to a reel is removably and spring ably fastened to the fishing pole (91) by placing the nose (48) into the eyelet (95); wherein the fishing line (99) is wrapped onto the trigger body (39) and the tail (63) into the fishing line groove (62) whereby the fishing pole is held in an arched position by a user (100) until a fish (150) pulls on a hook (98) which is attached to the fishing line (99) and which dislodges the nose (49) from the eyelet (95) thereby releasing the rod (91) and creates a spring force that immediately translates to a line force (114) and thereby sets the hook (98) into a mouth of the fish (150); wherein the adjustable trigger sensitivity results when the tension cord (50) is slidably positioned at multiple indicator marks (46) on the body (40) to correspond to a release force (F) that rotates the body (40); and wherein said release force (F) is determined by positioning the tension cord (50) at nearly unlimited marks (46) on the body (40) which directly corresponds to line force (114) to set force to the hook (98).

15. The special hook setting device (30) in claim 14 wherein the body (40) is further comprised of a separate clip piece (41) to mechanically grip the body and slidably retain a tension knot (55).

16. The special hook setting device (30) in claim 14 wherein the set of indicator marks (46) of the body (40) further comprise an indicator mark “L” (46L) meaning light release force and being farthest from the mouth (48) and the nose (49) and an indicator mark “H” (46L) meaning light release force and being nearest to the mouth (48) and the nose (49).

17. The special hook setting device (30) in claim 14 wherein the durable material is selected from the group consisting of a metal, a plastic/polymer, and a composite material.

18. The special hook setting device (30) in claim 14 wherein the means (55) is selected from the group consisting of an overhand knot, an anchor hitch knot, a fisherman's hitch, a clove hitch, a square knot, and a studding sail knot.

19. The special hook setting device (30) in claim 14 wherein the user (100) is selected from the group consisting of experienced anglers with multiple poles, novice anglers with little experience, children, elderly people, and physically or mentally challenged special needs persons.

20. The special hook setting device (30) in claim 14 wherein the different types of fishing are selected from the group consisting of still lake and pond fishing, sea and ocean fishing with waves and tidal movement, river and stream fishing with currents, boat and pontoon platform fishing, slow-trolling and surf fishing, ice fishing, and bank and bridge fishing.
